(19) United States
(12) Patent Application Publication
(10) Pub. No.: US 2007/0149745 A1
(43) Pub. Date: Jun. 28, 2007

(54) Polydiorganosiloxane-containing materials with oxalylamino groups

(75) Inventors: Charles M. Leir, Falcon Heights, MN (US); Karl E. Benson, St. Paul, MN (US); Richard G. Hansen, Mahtomedi, MN (US); Mark D. Purgett, Oakdale, MN (US); Albert I. Everaerts, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/317,616

(22) Filed: Dec. 23, 2005

(51) Int. Cl. C08G 77/26; C08L 83/04

(52) U.S. Cl. 528/38; 528/26; 525/477

(57) ABSTRACT

Polydiorganosiloxane-containing materials having at least two oxalylamino groups and methods of making such materials are described.

### TECHNICAL FIELD

Compounds containing at least one polydiorganosiloxane segment and at least two oxalylamino groups and methods of making these compounds are described.

### BACKGROUND

Siloxane polymers have unique properties derived mainly from the physical and chemical characteristics of the siloxane bond. These properties include low glass transition temperature, thermal and oxidative stability, resistance to ultraviolet radiation, low surface energy and hydrophobicity, high permeability to many gases, and biocompatibility. The siloxane polymers, however, often lack tensile strength.

The low tensile strength of the siloxane polymers can be improved by forming block copolymers. Some block copolymers contain a “soft” siloxane polymeric block or segment and any of a variety of “hard” blocks or segments. Exemplary block copolymers include polydiorganosiloxane polyamides and polydiorganosiloxane polyureas.

Polydiorganosiloxane polyamides have been prepared by condensation reactions of amino terminated silicones with short-chained dicarboxylic acids. Alternatively, these copolymers have been prepared by condensation reactions of carboxy terminated silicones with short-chained diamines. Because polydiorganosiloxanes (e.g., polydimethylsiloxanes) and polyamides often have significantly different solubility parameters, it can be difficult to find reaction conditions for production of siloxane-based polyamides that result in high degrees of polymerization, particularly with larger homologs of the polydiorganosiloxane segments. Many of the known siloxane-based polyamide copolymers contain relatively short segments of the polydiorganosiloxane (e.g., polydimethylsiloxane) such as segments having no greater than about 30 diorganosiloxy (e.g., dimethylsiloxy) units or the amount of the polydiorganosiloxane segment in the copolymer is relatively low. That is, the fraction (i.e., amount based on weight) of polydiorganosiloxane soft segments in the resulting copolymers tends to be low.

### SUMMARY

Polydiorganosiloxane-containing compounds having at least two oxalylamino groups and methods of making these compounds are provided. The compounds can be used as precursors for the preparation of various polymeric materials such as, for example, polydiorganosiloxane polyoxamides.

In one aspect, a compound is provided of Formula I. 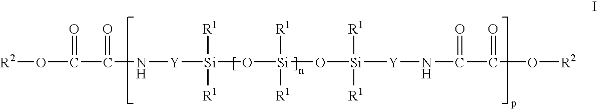
In this formula, each R¹ is independently an alkyl, haloalkyl, aralkyl, alkenyl, aryl, or aryl substituted with an alkyl, alkoxy, or halo. Each R² is independently an alkyl, haloalkyl, aryl, or aryl substituted with an alkyl, alkoxy, halo, or alkoxycarbonyl. Each Y is independently an alkylene, aralkylene, or a combination thereof. Each subscript n is independently an integer of 0 to 1500 and subscript p is an integer of 1 to 10.

In a second aspect, a composition is provided that includes
a) at least one first compound of Formula II; and 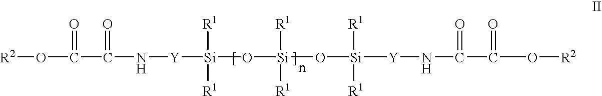
b) at least one second compound of Formula III. 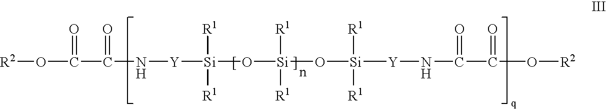
In these formulas, each R¹ is independently an alkyl, haloalkyl, aralkyl, alkenyl, aryl, or aryl substituted with an alkyl, alkoxy, or halo. Each R² is independently an alkyl, haloalkyl, aryl, or aryl substituted with an alkyl, alkoxy, halo, or alkoxycarbonyl. Each Y is independently an alkylene, aralkylene, or a combination thereof. Each subscript n is independently an integer of 0 to 1500 and subscript q is an integer of 2 to 10.

In the third aspect, a method is provided for making a compound of Formula I. 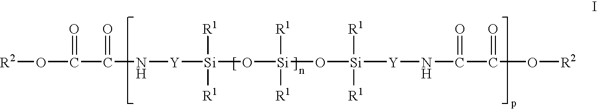
The method includes mixing together under reaction conditions a polydiorganosiloxane diamine of Formula IV 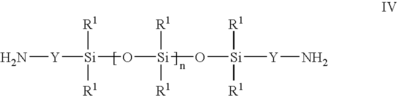
and a molar excess of an oxalate of Formula V. 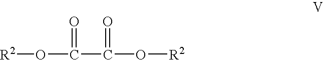
In these formulas, each R¹ is independently an alkyl, haloalkyl, aralkyl, alkenyl, aryl, or aryl substituted with an alkyl, alkoxy, or halo. Each R² is independently an alkyl, haloalkyl, aryl, or aryl substituted with an alkyl, alkoxy, halo, or alkoxycarbonyl. Each Y is independently an alkylene, aralkylene, or a combination thereof. Each subscript n is independently an integer of 0 to 1500 and subscript p is an integer of 1 to 10.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### DETAILED DESCRIPTION OF THE INVENTION

Compounds containing a polydiorganosiloxane segment and having at least two oxalylamino groups are provided. Additionally, methods of making these compounds are provided. The compounds can be used as precursors for the preparation of various polymeric materials such as, for example, polydiorganosiloxane polyoxamide block copolymers.

Definitions

The terms “a”, “an”, and “the” are used interchangeably with “at least one” to mean one or more of the elements being described.

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 20 carbon atoms. In some embodiments, the alkenyl contains 2 to 18, 2 to 12, 2 to 10, 4 to 10, 4 to 8, 2 to 8, 2 to 6, or 2 to 4 carbon atoms. Exemplary alkenyl groups include ethenyl, n-propenyl, and n-butenyl.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “alkoxy” refers to a monovalent group of formula —OR where R is an alkyl group.

The term “alkoxycarbonyl” refers to a monovalent group of formula —(CO)OR where R is an alkyl group and (CO) denotes a carbonyl group with the carbon attached to the oxygen with a double bond.

The term “aralkyl” refers to a monovalent group of formula —R^{a}—Ar where R^{a} is an alkylene and Ar is an aryl group. That is, the aralkyl is an alkyl substituted with an aryl.

The term “aralkylene” refers to a divalent group of formula —R^{a}—Ar^{a}— where R^{a} is an alkylene and Ar^{a} is an arylene (i.e., an alkylene is bonded to an arylene).

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “aryloxy” refers to a monovalent group of formula —OAr where Ar is an aryl group.

The term “carbonyl” refers to a divalent group of formula —(CO)— where the carbon atom is attached to the oxygen atom with a double bond.

The term “halo” refers to fluoro, chloro, bromo, or iodo.

The term “haloalkyl” refers to an alkyl having at least one hydrogen atom replaced with a halo. Some haloalkyl groups are fluoroalkyl groups, chloroalkyl groups, and bromoalkyl groups.

The term “heteroalkylene” refers to a divalent group that includes at least two alkylene groups connected by a thio, oxy, or —NR— where R is alkyl. The heteroalkylene can be linear, branched, cyclic, or combinations thereof and can include up to 60 carbon atoms and up to 15 heteroatoms. In some embodiments, the heteroalkylene includes up to 50 carbon atoms, up to 40 carbon atoms, up to 30 carbon atoms, up to 20 carbon atoms, or up to 10 carbon atoms. Some heteroalkylenes are polyalkylene oxides where the heteroatom is oxygen.

The term “oxalyl” refers to a divalent group of formula —(CO)—(CO)— where each (CO) denotes a carbonyl group.

The terms “oxalylamino” and “aminoxalyl” are used interchangeably to refer to a divalent group of formula —(CO)—(CO)—NH— where each (CO) denotes a carbonyl group.

The term “aminoxalylamino” refers to a divalent group of formula —NH—(CO)—(CO)—NR^{d}— where each (CO) denotes a carbonyl group and R^{d} is hydrogen, alkyl, or part of a heterocyclic group along with the nitrogen to which it is attached. In most embodiments, R^{d} is hydrogen or alkyl. In many embodiments, R^{d} is hydrogen.

The term “alkoxyoxalylamino” refers to a monovalent group of formula RO—(CO)—(CO)—NH— where R is an alkyl and each (CO) denotes a carbonyl group.

The term “haloalkoxyoxalylamino” refers to a monovalent group of formula R^{b}O—(CO)—(CO)—NH— where R^{b} is a haloalkyl and each (CO) denotes a carbonyl group.

The term “aryloxyoxalylamino” refers to a monovalent group of formula ArO—(CO)—(CO)—NH— where Ar is an aryl and each (CO) denotes a carbonyl group. The aryl can be unsubstituted or substituted with an alkyl, alkoxy, halo, or alkoxycarbonyl.

The terms “polymer” and “polymeric material” refer to materials prepared from one monomer such as a homopolymer or to materials prepared from two or more monomers such as a copolymer, terpolymer, or the like. Likewise, the term “polymerize” refers to the process of making a polymeric material that can be a homopolymer, copolymer, terpolymer, or the like. The terms “copolymer” and “copolymeric material” refer to a polymeric material prepared from at least two monomers.

The term “polydiorganosiloxane” refers to a divalent segment of formula 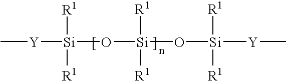
where each R¹ is independently an alkyl, haloalkyl, aralkyl, alkenyl, aryl, or aryl substituted with an alkyl, alkoxy, or halo; each Y is independently an alkylene, aralkylene, or a combination thereof; and subscript n is independently an integer of 0 to 1500.

The terms “room temperature” and “ambient temperature” are used interchangeable to refer to a temperature in the range of 20° C. to 25° C.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

Compounds and Compositions

A compound is provided of Formula I. 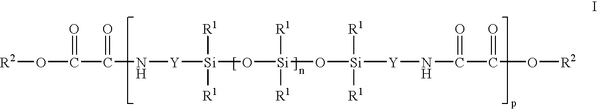
In this formula, each R¹ is independently an alkyl, haloalkyl, aralkyl, alkenyl, aryl, or aryl substituted with an alkyl, alkoxy, or halo. Each R² is independently an alkyl, haloalkyl, aryl, or aryl substituted with an alkyl, alkoxy, halo, or alkoxycarbonyl. Each Y is independently an alkylene, aralkylene, or a combination thereof. Each subscript n is independently an integer of 0 to 1500 and subscript p is an integer of 1 to 10.

Suitable alkyl groups for R¹ typically have 1 to 10 carbon atoms, 1 to 6 carbon atoms, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have 3 to 10 carbon atoms and only a portion of the hydrogen atoms are replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 10, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. An aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy with 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group having 1 to 10 carbon atoms and an aryl group with 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl with phenyl bonded to an alkylene).

In some compounds of Formula I, at least 50 percent of the R¹ groups are methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo.

Each Y in Formula I is independently an alkylene, aralkylene, or a combination thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group having 6 to 12 carbon atoms bonded to an alkylene group having 1 to 10 carbon atoms. In some exemplary aralkylene groups, the arylene group is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

The compounds of Formula I have groups of formula R²O—(CO)—(CO)—NH— at each end of the molecule. That is, the compounds have at least two oxalylamino groups. Each R² is independently an alkyl, haloalkyl, aryl, or aryl substituted with an alkyl, alkoxy, halo, or alkoxycarbonyl. The group of formula R²⁰—(CO)—(CO)—NH— is an alkoxyoxalylamino group when R² is an alkyl, a haloalkoxyoxalylamino group when R² is a haloalkyl, or an aryloxyoxalylamino group when R² is an unsubstituted or substituted aryl.

Suitable alkyl and haloalkyl groups for R² often have 1 to 10, 1 to 6, or 1 to 4 carbon atoms. Although tertiary alkyl (e.g., tert-butyl) and tertiary haloalkyl groups can be used, a primary or secondary carbon atom is often attached directly (i.e., bonded) to the adjacent oxy group. Exemplary alkyl groups include methyl, ethyl, n-propyl, iso-propyl, n-butyl, and iso-butyl. Exemplary haloalkyl groups include chloroalkyl groups and fluoroalkyl groups in which some, but not all, of the hydrogen atoms on the corresponding alkyl group are replaced with halo atoms. For example, the chloroalkyl or fluoroalkyl groups can be chloromethyl, 2-chloroethyl, 2,2,2-trichloroethyl, 3-chloropropyl, 4-chlorobutyl, fluoromethyl, 2-fluoroethyl, 2,2,2-trifluoroethyl, 3-fluoropropyl, 4-fluorobutyl, and the like.

Suitable aryl groups for R² include those having 6 to 12 carbon atoms such as, for example, phenyl. An aryl group can be unsubstituted or substituted with an alkyl (e.g., an alkyl having 1 to 4 carbon atoms such as methyl, ethyl, or n-propyl), an alkoxy (e.g., an alkoxy having 1 to 4 carbon atoms such as methoxy, ethoxy, or propoxy), halo (e.g., chloro, bromo, or fluoro), or alkoxycarbonyl (e.g., an alkoxycarbonyl having 2 to 5 carbon atoms such as methoxycarbonyl, ethoxycarbonyl, or propoxycarbonyl).

Each subscript n in Formula I is independently an integer of 0 to 1500. For example, subscript n can be an integer up to 1000, up to 500, up to 400, up to 300, up to 200, up to 100, up to 80, up to 60, up to 40, up to 20, or up to 10. The value of n is often at least 1, at least 2, at least 3, at least 5, at least 10, at least 20, or at least 40. For example, subscript n can be in the range of 40 to 1500, 0 to 1000, 40 to 1000, 0 to 500, 1 to 500, 40 to 500, 1 to 400, 1 to 300, 1 to 200, 1 to 100, 1 to 80, 1 to 40, or 1 to 20.

Subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1 to 4.

Exemplary compounds according to Formula I include, but are not limited to, those in which R¹ is methyl and in which the two R² groups are the same. For example, both R² groups can be an alkyl having 1 to 4 carbon atoms, haloalkyl having 1 to 4 carbon atoms, phenyl, phenyl substituted with an alkoxycarbonyl having 2 to 5 carbon atoms, phenyl substituted with at least one halo group, or phenyl substituted with an alkoxy having 1 to 4 carbon atoms.

The compounds of Formula I often have a molecular weight of at least 1,000 g/mole, at least 2,000 g/mole, at least 3,000 g/mole, at least 4,000 g/mole, at least 5,000 g/mole, at least 10,000 g/mole, at least 20,000 g/mole, or at least 50,000 g/mole. In some embodiments, the molecular weight is in the range of 5,000 to 50,000 g/mole, in the range of 10,000 to 50,000 g/mole, or in the range of 20,000 to 50,000 g/mole.

The compounds of Formula I can be used as precursors for the preparation of various polymeric materials. For example, the compounds can undergo a condensation reaction when combined with a diamine (i.e., a diamine having two primary amino groups, two secondary amino groups, or one primary amino group and one secondary amino group) to form polydiorganosiloxane polyoxamide copolymers having a plurality of aminoxalylamino groups. The polydiorganosiloxane polyoxamide copolymers can be elastomeric materials.

In some embodiments of Formula I, there is a single value for subscript p. In other embodiments, there can be a mixture of compounds according to Formula I (i.e., a mixture of compounds with different values of p). For example, the compounds can be present as a composition that includes
a) at least one first compound of Formula II; and 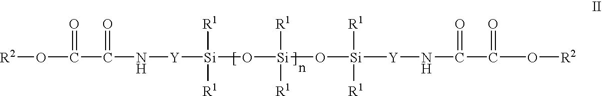
b) at least one second compound of Formula III.

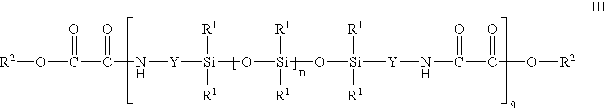

The groups R¹, R², and n are the same as defined above for Formula I. The subscript q is an integer equal to 2 to 10. The subscript q is often at least 3, at least 4, or at least 5. The value of q is often an integer up to 9, up to 8, up to 7, or up to 6. The compounds of Formula II and Formula III are terminated with oxalylamino-containing groups. The compounds of Formula III contain one or more aminoxalylamino groups. Formula II corresponds to Formula I where p is equal to 1. Formula III corresponds to Formula I where p is at least 2.

Similarly to the compounds of Formula I, the mixture of compounds of Formulas II and III can be used as precursors for the preparation of various polymeric materials. For example, the mixture of compounds of Formulas II and III can undergo a condensation reaction when combined with a diamine to form polydiorganosiloxane polyoxamide copolymers, which can be elastomeric materials. Different amounts of the chain-extended compound of Formula III in the mixture can affect the final properties of the copolymer. That is, the amount of the second compound of Formula III can be varied advantageously to provide a range of elastomeric materials with different properties. For example, a higher amount of the second compound of Formula III can change the melt rheology (e.g., the elastomeric material can flow easier when in the molten state), can change the softness of the elastomeric material, can lower the modulus of the elastomeric material, or a combination thereof.

Exemplary mixtures include at least 50 weight percent of the first compound of Formula II and no greater than 50 weight percent of the second compound of Formula III based on the sum of the weight of the first and second compounds in the mixture. The first compound of Formula II can include a plurality of compounds with different values of n. The second compound of Formula III can include a plurality of compounds with different values of n, different values of q, or different values of both q and n. In some mixtures, the first compound is present in an amount of at least 55 weight percent, at least 60 weight percent, at least 65 weight percent, at least 70 weight percent, at least 75 weight percent, at least 80 weight percent, at least 85 weight percent, at least 90 weight percent, at least 95 weight percent, or at least 98 weight percent based on the weight of the first and second compounds in the mixture. The mixtures often contain no greater than 50 weight percent, no greater than 45 weight percent, no greater than 40 weight percent, no greater than 35 weight percent, no greater than 30 weight percent, no greater than 25 weight percent, no greater than 20 weight percent, no greater than 15 weight percent, no greater than 10 weight percent, no greater than 5 weight percent, or no greater than 2 weight percent of the second compound.

For example, mixtures can include 50 to 99 weight percent of the first compound and 1 to 50 weight percent of the second compound based on the sum of the weight of the first and second compounds in the mixture. Some mixtures include 50 to 95 weight percent of the first compound and 5 to 50 weight percent of the second compound, 50 to 90 weight percent of the first compound and 10 to 50 weight percent of the second compound, or 50 to 80 weight percent of the first compound and 20 to 50 weight percent of the second compound.

Methods of Making Compounds

The compounds of Formula I can be prepared by reacting a polydiorganosiloxane diamine of Formula IV (p moles) with a molar excess of an oxalate of Formula V (greater than p+1 moles) according to Reaction Scheme A to produce the polydiorganosiloxane-containing precursor of Formula I and R²—OH by-product. 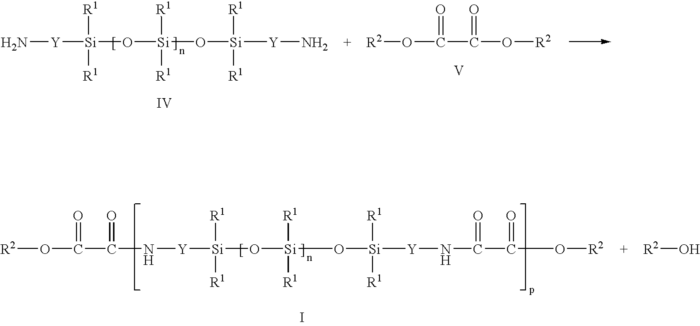
Groups R¹, R², Y, and n are the same as described above for Formula I. The two R² groups in the oxalate of Formula V can be the same or different. In some methods, the two R² groups are different and have different reactivity with the polydiorganosiloxane diamine of Formula IV.

The oxalates of Formula V can be prepared, for example, by reacting an alcohol of formula R²—OH with an oxalyl dichloride. Commercially available oxalates of Formula V (e.g., from Sigma-Aldrich, Milwaukee, Wis. and from VWR International, Bristol, Conn.) include, but are not limited to, dimethyl oxalate, diethyl oxalate, di-n-butyl oxalate, di-tert-butyl oxalate, bis(phenyl) oxalate, bis(pentafluorophenyl) oxalate, 1-(2,6-difluorophenyl)-2-(2,3,4,5,6-pentachlorophenyl) oxalate, and bis (2,4,6-trichlorophenyl) oxalate.

The polydiorganosiloxane diamine of Formula IV can be prepared by any known method and can have any suitable molecular weight, such as an average molecular weight in the range of 700 to 150,000 g/mole. Suitable polydiorganosiloxane diamines and methods of making the polydiorganosiloxane diamines are described, for example, in U.S. Pat. No. 3,890,269 (Martin), U.S. Pat. No. 4,661,577 (Jo Lane et al.), U.S. Pat. No. 5,026,890 (Webb et al.), U.S. Pat. No. 5,276,122 (Aoki et al.), U.S. Pat. No. 5,214,119 (Leir et al.), U.S. Pat. No. 5,461,134 (Leir et al.), U.S. Pat. No. 5,512,650 (Leir et al.), and U.S. Pat. No. 6,355,759 (Sherman et al.), incorporated herein by reference in their entirety. Some polydiorganosiloxane diamines are commercially available, for example, from Shin Etsu Silicones of America, Inc., Torrance, Calif. and from Gelest Inc., Morrisville, Pa.

A polydiorganosiloxane diamine having a molecular weight greater than 2,000 g/mole or greater than 5,000 g/mole can be prepared using the methods described in U.S. Pat. No. 5,214,119 (Leir et al.), U.S. Pat. No. 5,461,134 (Leir et al.), and U.S. Pat. No. 5,512,650 (Leir et al.). One of the described methods involves combining under reaction conditions and under an inert atmosphere (a) an amine functional end blocker of the following formula 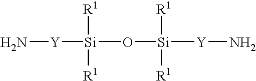
where Y and R¹ are the same as defined for Formula I; (b) sufficient cyclic siloxane to react with the amine functional end blocker to form a polydiorganosiloxane diamine having a molecular weight less than 2,000 g/mole; and (c) an anhydrous aminoalkyl silanolate catalyst of the following formula 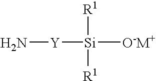
where Y and R¹ are the same as defined in Formula I and M⁺ is a sodium ion, potassium ion, cesium ion, rubidium ion, or tetramethylammonium ion. The reaction is continued until substantially all of the amine functional end blocker is consumed and then additional cyclic siloxane is added to increase the molecular weight. The additional cyclic siloxane is often added slowly (e.g., drop wise). The reaction temperature is often conducted in the range of 80° C. to 90° C. with a reaction time of 5 to 7 hours. The resulting polydiorganosiloxane diamine can be of high purity (e.g., less than 2 weight percent, less than 1.5 weight percent, less than 1 weight percent, less than 0.5 weight percent, less than 0.1 weight percent, less than 0.05 weight percent, or less than 0.01 weight percent silanol impurities). Altering the ratio of the amine functional end blocker to the cyclic siloxane can be used to vary the molecular weight of the resulting polydiorganosiloxane diamine of Formula IV.

Another method of preparing the polydiorganosiloxane diamine of Formula IV includes combining under reaction conditions and under an inert atmosphere (a) an amine functional end blocker of the following formula 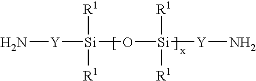
where R¹ and Y are the same as described for Formula I and where the subscript x is equal to an integer of 1 to 150; (b) sufficient cyclic siloxane to obtain a polydiorganosiloxane diamine having an average molecular weight greater than the average molecular weight of the amine functional end blocker; and (c) a catalyst selected from cesium hydroxide, cesium silanolate, rubidium silanolate, cesium polysiloxanolate, rubidium polysiloxanolate, and mixtures thereof. The reaction is continued until substantially all of the amine functional end blocker is consumed. This method is further described in U.S. Pat. No. 6,355,759 B1 (Sherman et al.). This procedure can be used to prepare any molecular weight of the polydiorganosiloxane diamine.

Yet another method of preparing the polydiorganosiloxane diamine of Formula IV is described in U.S. Pat. No. 6,531,620 B2 (Brader et al.). In this method, a cyclic silazane is reacted with a siloxane material having hydroxy end groups as shown in the following reaction. 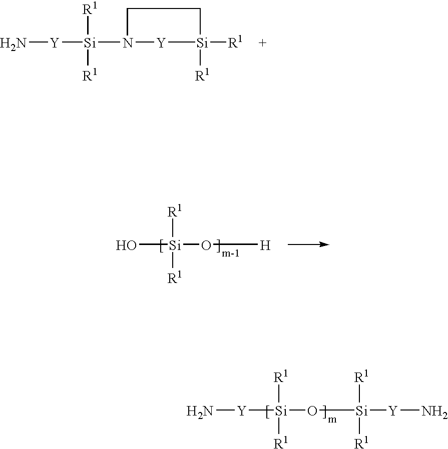
The groups R¹ and Y are same as described for Formula I. The subscript m is an integer greater than 1.

Examples of polydiorganosiloxane diamines include, but are not limited to, polydimethylsiloxane diamine, polydiphenylsiloxane diamine, polytrifluoropropylmethylsiloxane diamine, polyphenylmethylsiloxane diamine, polydiethylsiloxane diamine, polydivinylsiloxane diamine, polyvinylmethylsiloxane diamine, poly(5-hexenyl)methylsiloxane diamine, and mixtures thereof.

In Reaction Scheme A, the polydiorganosiloxane diamine of Formula IV is reacted with a molar excess of the oxalate of Formula V to produce a compound of Formula I. That is, the molar ratio of oxalate to polydiorganosiloxane diamine is greater than (p+1): p. The molar ratio is often greater than 2:1, greater than 3:1, greater than 4:1, or greater than 6:1. The condensation reaction typically occurs under an inert atmosphere and at room temperature upon mixing of the components.

The condensation reaction shown in Reaction Scheme A can occur in the presence or in the absence of a solvent. In some methods, no solvent or only a small amount of solvent is included in the reaction mixture. The absence of a solvent can be desirable when the removal of the solvent would be advantageous for the subsequent use of the product of the condensation reaction. In other methods, a solvent may be included such as toluene, tetrahydrofuran, dichloromethane, or aliphatic hydrocarbons (e.g., alkanes such as hexane).

The excess oxalate can typically be removed from the desired product of the condensation reaction (i.e., from a compound or compounds of Formula I) using a stripping process. For example, the reacted mixture (i.e., the product or products of Reaction Scheme A) can be heated to a temperature no greater than 150° C., no greater than 175° C., no greater than 200° C., no greater than 225° C., or no greater than 250° C. to volatilize the excess oxalate. A vacuum can be pulled to lower the temperature that is needed for removal of the excess oxalate. The compounds of Formula I tend to undergo minimal or no apparent degradation at temperatures up to 250° C. Any other known methods of removing the excess oxalate can be used.

The by-product of the condensation reaction shown in Reaction Scheme A is an alcohol (i.e., R²—OH is an alcohol). Group R² is often limited to an alkyl having 1 to 4 carbon atoms, a haloalkyl having 1 to 4 carbon atoms, or an aryl such as phenyl that forms an alcohol that can be readily removed (e.g., vaporized) by heating at temperatures no greater than about 250° C. Such an alcohol can be removed when the reacted mixture is heated to a temperature sufficient to remove the excess oxalate of Formula V.

The compounds of Formulas I, II, and III can be used as precursors to prepare copolymers that include a polydiorganosiloxane segment. For example, the precursors of Formula I, II, and III can be reacted with a diamine of formula R³HN-G-NHR³ to form a polydiorganosiloxane polyoxamide having at least two of the following repeat units of Formula VI. 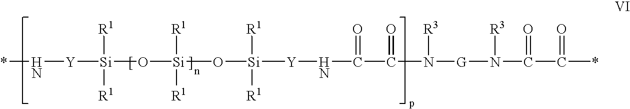
In this formula, Y, R¹, n and p are the same as described for Formula I. Each asterisk in Formula VI indicates the position of attachment of the repeating unit to another group such as another repeat unit. Group G is a divalent group that is the residue unit that is equal to a diamine minus the two amino groups, where the amino groups are two primary amino groups, two secondary amino groups, or one primary amino group and one secondary amino group. The diamine is of formula HR³N-G-NHR³ where R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., piperazine). In most embodiments, R³ is hydrogen or alkyl. In many embodiments, R³ is hydrogen and the diamine is of formula H₂N-G-NH₂.

In some examples, G is an alkylene (i.e., the diamine is an alkylene diamine), heteroalkylene (i.e., the diamine is a heteroalkylene diamine), polydiorganosiloxane (i.e., the diamine is a polydiorganosiloxane diamine), arylene (i.e., the diamine is an arylene diamine), aralkylene (i.e., the diamine is an aralkylene diamine), or a combination thereof. Group G is usually free of carbonyl groups and additional primary or secondary amino groups.

The polydiorganosiloxane polyoxamides tend to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group (i.e., each carbonyl is part of an oxalyl group). More specifically, the polydiorganosiloxane polyoxamide has a plurality of aminoxalylamino groups. The polydiorganosiloxane polyoxamides are further described in co-pending application with Attorney Docket No. 61370US002 filed on the same day as the present application, incorporated herein by reference in its entirety.

The polydiorganosiloxane polyoxamide is a linear, block copolymer and can be an elastomeric material. These copolymers can be cast from solvents as film, molded or embossed into various shapes, or extruded into films. The high temperature stability of the polydiorganosiloxane polyoxamides makes them well suited for extrusion methods of film formation. The films can be optically clear. A multilayer film containing the polydiorganosiloxane polyoxamide block copolymers is further described in copending patent application with Attorney Docket No. 61494US002 filed on the same day as the present application, incorporated herein by reference in its entirety. Alternatively, the polydiorganosiloxane polyoxamides can be formulated into adhesive compositions. The adhesives can be optically clear. Such adhesive compositions are further described in copending patent application with Attorney Docket No. 61371US002 filed on the same day as the present application, incorporated herein by reference in its entirety.

The foregoing describes the invention in terms of embodiments foreseen by the inventors for which an enabling description was available, notwithstanding that insubstantial modifications of the invention, not presently foreseen, may nonetheless represent equivalents thereto.

### EXAMPLES

These examples are merely for illustrative purposes only and are not meant to be limiting on the scope of the appended claims. All parts, percentages, ratios, and the like in the examples are by weight, unless noted otherwise. Solvents and other reagents used were obtained from Sigma-Aldrich Chemical Company; Milwaukee, Wis. unless otherwise noted.

Table of Abbreviations

| Abbreviation | |
|---|---|
| or Trade | |
| Designation | Description |
| 5K PDMS | Polydimethylsiloxane diamine with an approximate |
| diamine | molecular weight of 5,000 g/mole that was prepared |
| | as described in U.S. Pat. No. 5,214,119. |
| 14K PDMS | Polydimethylsiloxane diamine with an approximate |
| diamine | molecular weight of 14,000 g/mole that was prepared |
| | as described in U.S. Pat. No. 6,355,759. |
| 33K PDMS | Polydimethylsiloxane diamine with an approximate |
| diamine | molecular weight of 33,000 g/mole that was prepared |
| | as described in U.S. Pat. No. 6,355,759. |
| DMS-A12 | Polydimethylsiloxane diamine with an approximate |
| | molecular weight of 900 g/mole that was purchased |
| | from Gelest, Inc., Morrisville, PA |
| DMS-A15 | Polydimethylsiloxane diamine with an approximate |
| | molecular weight of 2,500 g/mole that was purchased |
| | from Gelest, Inc., Morrisville, PA |
| THF | tetrahydrofuran |

### Test Methods

Titration Method to Determine Equivalent Weight

Approximately 10 grams (precisely weighed) of the precursor compound of Formula I was added to ajar. Approximately 50 grams THF solvent (not precisely weighed) was added. The contents were mixed using a magnetic stir bar mixer until the mixture was homogeneous. The theoretical equivalent weight of precursor was calculated and then an amount of N-hexylamine (precisely weighed) in the range of 3 to 4 times this number of equivalents was added. The reaction mixture was stirred for a minimum of 4 hours. Bromophenol blue (10-20 drops) was added and the contents were mixed until homogeneous. The mixture was titrated to a yellow endpoint with 1.0N (or 0.1N) hydrochloric acid. The number of equivalents of precursor was equal to the number of equivalents of N-hexylamine added to the sample minus the number of equivalents of hydrochloric acid added during titration. The equivalent weight (grams/equivalent) was equal to the sample weight of the precursor divided by the number of equivalents of the precursor.

### Preparative Example 1

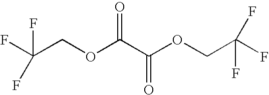

Oxalyl dichloride (220.66 grams) and trifluoroethanol (400 grams) were placed in a 1 liter flask equipped with a magnetic stirrer, nitrogen inlet, slight nitrogen flow, and a condenser exhausted to a scrubber. The scrubber included a vigoreaux condenser with a water stream flowing through it to absorb hydrochloric acid. The mixture was heated with stirring to reflux and then refluxed for two hours. Gas chromatography was used to confirm that the reaction was complete. The mixture was distilled under vacuum (133 Pascals, 1 Torr) and the fraction with a boiling point of 46° C. was collected. The product was 401.4 grams (90.8% yield) of a clear colorless liquid.

### Example 1

Diethyl oxalate (241.10 grams) was placed in a 3 liter, 3-neck resin flask equipped with a mechanical stirrer, heating mantle, nitrogen inlet tube (with stopcock), and an outlet tube. The flask was purged with nitrogen for 15 minutes and 5K PDMS diamine (2,028.40 grams) was added slowly with stirring. After 8 hours at room temperature, the reaction flask was fitted with a distillation adaptor and receiver. The contents were stirred and heated to 150° C. under vacuum (133 Pascals, 1 Torr) for 4 hours, until no further distillate was able to be collected. The remaining liquid was cooled to room temperature to provide 2,573 grams of a compound according to Formula I. Gas chromatographic analysis of the clear, mobile liquid showed that no detectable level of diethyl oxalate remained. The molecular weight was determined using ¹H NMR (molecular weight equal to 5,477 grams/mole) and by titration (equivalent weights of 2,722 grams/equivalent and 2,721 grams/equivalent for two samples titrated).

### Example 2

Diethyl oxalate (326.00 grams) was placed in a 2 liter, 3-neck resin flask equipped with a mechanical stirrer, heating mantle, nitrogen inlet tube (with stopcock), and an outlet tube. The flask was purged with nitrogen for 15 minutes and then, with vigorous stirring, DMS-A12 (497.50 grams) was added dropwise. This reaction mixture was stirred for approximately one hour at room temperature and then for 75 minutes at 80° C. The reaction flask was fitted with a distillation adaptor and receiver. The reaction mixture was heated to 120° C. under vacuum (133 Pascals, 1 Torr) for 2 hours, until no further distillate was able to be collected. The reaction mixture was cooled to room temperature to provide the compound of Formula I. Gas chromatographic analysis of the clear, mobile liquid showed that no detectable level of diethyl oxalate remained. The ester equivalent weight was determined using ¹H NMR (equivalent weight equal to 923 grams/equivalent) and by titration (equivalent weight equal to 910 grams/equivalent).

### Example 3

DMS-A12 (500.00 grams) was placed in a 2 liter, 3-neck resin flask equipped with a mechanical stirrer, heating mantle, nitrogen inlet tube (with stopcock), and an outlet tube. The flask was purged with nitrogen for 15 minutes and then, with vigorous stirring, diethyl oxalate (324.76 grams) was added dropwise. This reaction mixture was stirred for approximately one hour at room temperature and then for 75 minutes at 80° C. The reaction flask was fitted with a distillation adaptor and receiver. The reaction mixture was heated under vacuum (133 Pascals, I Torr) for 2 hours at 120° C. and then 30 minutes at 130° C., until no further distillate was able to be collected. The reaction mixture was cooled to room temperature to provide the compound of Formula I product. Gas chromatographic analysis of the clear, mobile liquid showed that no detectable level of diethyl oxalate remained. The ester equivalent weight was determined using ¹H NMR (equivalent weight equal to 1,293 grams/equivalent).

### Example 4

DMS-A15 (500.00 grams) was placed in a 2 liter, 3-neck resin flask equipped with a mechanical stirrer, heating mantle, nitrogen inlet tube (with stopcock), and an outlet tube. The flask was purged with nitrogen for 15 minutes and then, with vigorous stirring, diethyl oxalate (116.92 grams) was added dropwise. This reaction mixture was stirred for approximately one hour at room temperature and then for 75 minutes at 80° C. The reaction flask was fitted with a distillation adaptor and receiver. The reaction mixture was heated under vacuum (133 Pascals, 1 Torr) for 2 hours at 120° C. and then 30 minutes at 130° C., until no further distillate was able to be collected. The reaction mixture was cooled to room temperature to provide the compound of Formula I product. Gas chromatographic analysis of the clear, mobile liquid showed that no detectable level of diethyl oxalate remained. The ester equivalent weight was determined using ¹H NMR (equivalent weight equal to 1,788 grams/equivalent) and by titration (equivalent weight equal to 1,753 grams/equivalent).

### Example 5

A sample of 14K PDMS diamine (830.00 grams) was placed in a 2 liter, 3-neck resin flask equipped with a mechanical stirrer, heating mantle, nitrogen inlet tube (with stopcock), and an outlet tube. The flask was purged with nitrogen for 15 minutes and then, with vigorous stirring, diethyl oxalate (33.56 grams) was added dropwise. This reaction mixture was stirred for approximately one hour at room temperature and then for 75 minutes at 80° C. The reaction flask was fitted with a distillation adaptor and receiver. The reaction mixture was heated under vacuum (133 Pascals, 1 Torr) for 2 hours at 120° C. and then 30 minutes at 130° C., until no further distillate was able to be collected. The reaction mixture was cooled to room temperature to provide the compound of Formula I product. Gas chromatographic analysis of the clear, mobile liquid showed that no detectable level of diethyl oxalate remained. The ester equivalent weight was determined using ¹H NMR (equivalent weight equal to 7,916 grams/equivalent) and by titration (equivalent weight equal to 8,272 grams/equivalent).

### Example 6

A sample of 33K PDMS diamine (2028.40 grams) was placed in a 2 liter, 3-neck resin flask equipped with a mechanical stirrer, heating mantle, nitrogen inlet tube (with stopcock), and an outlet tube. The flask was purged with nitrogen for 15 minutes and then, with vigorous stirring, diethyl oxalate (35.50 grams) was added dropwise. This reaction mixture was stirred for approximately one hour at room temperature and then for 75 minutes at 80° C. The reaction flask was fitted with a distillation adaptor and receiver. The reaction mixture was heated under vacuum (133 Pascals, 1 Torr) for 4 hours at 160° C. until no further distillate was able to be collected. The reaction mixture was cooled to room temperature to provide the compound of Formula I product. Gas chromatographic analysis of the clear, mobile liquid showed that no detectable level of diethyl oxalate remained. The ester equivalent weight was determined using ¹H NMR (equivalent weight equal to 17,167 grams/equivalent).

### Example 7

Bis-trifluoroethyl oxalate (73.30 grams) and tetrahydrofuran (400 mL) were placed in a 1 liter flask. The mixture was chilled to −10° C. and 5K PDMS diamine (300.00 grams) was added to the flask with stirring. The mixture was allowed to warm to room temperature. The solvent was removed using a rotary evaporator. Excess bis-trifluoroethyl oxalate was distilled under vacuum (133 Pascals, I Torr) at 80° C. until no further distillate was collected. Gas chromatographic analysis of the clear, mobile liquid showed that no detectable level of bis-trifluoroethyl oxalate remained. The equivalent weight was determined using ¹H NMR (equivalent weight equal to 3,165 grams/equivalent).

We claim:

1. A compound of Formula I: 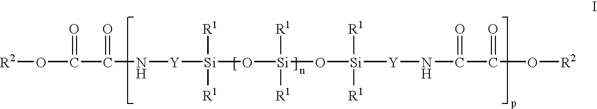
wherein
each R¹ is independently an alkyl, haloalkyl, aralkyl, alkenyl, aryl, or aryl substituted with an alkyl, alkoxy, or halo;
each R² is independently an alkyl, haloalkyl, aryl, or aryl substituted with an alkyl, alkoxy, halo, or alkoxycarbonyl;
each Y is independently an alkylene, aralkylene, or a combination thereof;
each n is independently an integer of 0 to 1500; and
p is an integer of 1 to 10.

2. The compound of claim 1, wherein R¹ is methyl.

3. The compound of claim 1, wherein at least 50 percent of the R¹ groups are methyl.

4. The compound of claim 1, wherein each R² is an alkyl having 1 to 4 carbon atoms or a haloalkyl having 1 to 4 carbon atoms, the alkyl or haloalkyl having a primary carbon atom or secondary carbon atom bonded to the adjacent oxy group.

5. The compound of claim 1, wherein each R² is a phenyl or a phenyl substituted with an alkyl having 1 to 4 carbon atoms, with an alkoxy having 1 to 4 carbon atoms, with a halo, or with an alkoxycarbonyl having 2 to 5 carbon atoms.

6. The compound of claim 1, wherein each Y is an alkylene having 1 to 10 carbon atoms, phenylene bonded to an alkylene having 1 to 10 carbon atoms, or phenylene bonded to a first alkylene having 1 to 10 carbon atoms and to a second alkylene having 1 to 10 carbon atoms.

7. The compound of claim 1, wherein n is an integer of 0 to 500.

8. The compound of claim 1, wherein p is an integer of 1 to 4.

9. A composition comprising:
a) at least one first compound of Formula II; and 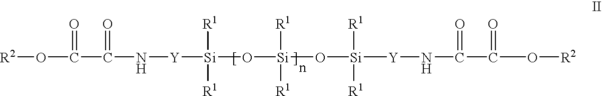
b) at least one second compound of Formula III 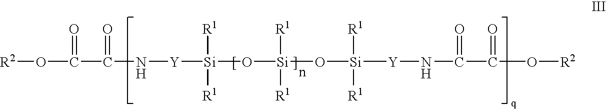
wherein
each R¹ is independently an alkyl, haloalkyl, aralkyl, alkenyl, aryl, or aryl substituted with an alkyl, alkoxy, or halo;
each R² is independently an alkyl, haloalkyl, aryl, or aryl substituted with an alkyl, alkoxy, halo, or alkoxycarbonyl;
each Y is independently an alkylene, aralkylene, or a combination thereof;
each n is independently an integer of 0 to 1500; and
q is an integer of 2 to 10.

10. The composition of claim 9, wherein R¹ is methyl.

11. The composition of claim 9, wherein each R² is an alkyl having 1 to 4 carbon atoms or a haloalkyl having 1 to 4 carbon atoms, the alkyl or haloalkyl having a primary carbon atom or secondary carbon atom bonded to the adjacent oxy group.

12. The composition of claim 9, wherein each R² is a phenyl or a phenyl substituted with an alkyl having 1 to 4 carbon atoms, with an alkoxy having 1 to 4 carbon atoms, with a halo, or with an alkoxycarbonyl having 2 to 5 carbon atoms.

13. The composition of claim 9, wherein each Y is an alkylene having 1 to 10 carbon atoms, phenylene bonded to an alkylene having 1 to 10 carbon atoms, or phenylene bonded to a first alkylene having 1 to 10 carbon atoms and to a second alkylene having 1 to 10 carbon atoms.

14. The composition of claim 9, wherein the composition comprises at least 50 weight percent of the first compound of Formula II and no greater than 50 weight percent of the second compound of Formula III based on the sum of the weight of the first and second compounds in the mixture.

15. A method of making a compound of Formula I, 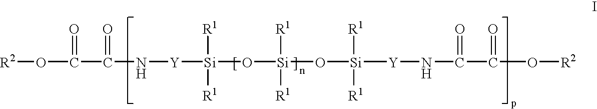
the method comprising mixing a polydiorganosiloxane diamine of Formula IV 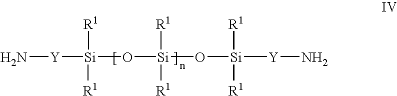
with a molar excess of an oxalate of Formula V, 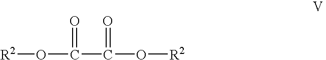
wherein
each R¹ is independently an alkyl, haloalkyl, aralkyl, alkenyl, aryl, or aryl substituted with an alkyl, alkoxy, or halo;
each R² is independently an alkyl, haloalkyl, aryl, or aryl substituted with an alkyl, alkoxy, halo, or alkoxycarbonyl;
each Y is independently an alkylene, aralkylene, or a combination thereof
n is independently an integer of 0 to 1500; and
p is an integer of 1 to 10.

16. The method of claim 15, wherein each R² is an alkyl having 1 to 4 carbon atoms or a haloalkyl having 1 to 4 carbon atoms, the alkyl or haloalkyl having a primary carbon atom or secondary carbon atom bonded to the adjacent oxy group.

17. The method of claim 15, wherein each R² is a phenyl or a phenyl substituted with an alkyl having 1 to 4 carbon atoms, with an alkoxy having 1 to 4 carbon atoms, with a halo, or with an alkoxycarbonyl having 2 to 5 carbon atoms.

18. The method of claim 15, further comprising removing the excess oxalate after reaction of the polydiorganosiloxane diamine and the oxalate.

19. The method of claim 15, wherein the two R² groups of the oxalate of Formula V are different.

20. The method of claim 15, wherein R¹ is methyl.
